(19) United States
(12) Patent Application Publication
(10) Pub. No.: US 2024/0402312 A1
(43) Pub. Date: Dec. 5, 2024

(54) RANGING DEVICE FOR CALCULATING A FLIGHT TIME OF LIGHT EMITTED FROM AN EMITTING DEVICE

(71) Applicant: CANON KABUSHIKI KAISHA, Tokyo (JP)

(72) Inventors: SHINYA IGARASHI, Kanagawa (JP); SHOGO YAMASAKI, Kanagawa (JP)

(21) Appl. No.: 18/671,695

(22) Filed: May 22, 2024

(30) Foreign Application Priority Data
May 30, 2023 (JP) 2023-088771

(51) Int. Cl. G01S 7/4865; G01S 7/4863; G01S 17/10; G01S 17/931

(52) U.S. Cl. CPC G01S 7/4865; G01S 7/4863; G01S 17/10; G01S 17/931

(57) ABSTRACT

A ranging device including: a control unit controlling a light emission timing in a light emitting device divided into emitting regions and a start timing of time counting; a receiving unit divided into receiving regions corresponding one-to-one to the emitting regions; a latch unit generating a light reception time value indicating an elapsed time from the start of the time counting to incidence of light based on the time count value and light reception signals; and a calculation unit calculating a flight time of light based on the light reception time value. Light emission timings of the emitting regions are different from each other, and a time difference between two light emission timings is shorter than a measurement period in each receiving region. The calculation unit calculates the flight time based on the light reception time value and the time difference.

### BACKGROUND

### Technical Field

The aspect of the embodiments relates to a ranging device.

### Description of the Related Art

Japanese Patent Application Laid-Open No. 2021-120630 discloses a ranging device that measures a distance to an object based on a time difference between a time at which light is irradiated and a time at which reflected light is received. The ranging device of Japanese Patent Application Laid-Open No. 2021-120630 includes a light emitting element array including a plurality of light emitting elements, and the plurality of light emitting elements are divided into a plurality of regions in which light emission timings are different from each other. According to this method, the average energy of light emitted within a predetermined period can be reduced, so that the intensity of light emitted from the light emitting element can be increased while satisfying the eye safety standard. Thus, since the intensity of the reflected light is increased and the number of repetitions of the measurement can be reduced, the effect of enlargement of the ranging range and improvement of the frame rate can be obtained.

In the ranging device disclosed in Japanese Patent Application Laid-Open No. 2021-120630, the measurement periods corresponding to the respective regions do not overlap temporally. Therefore, since the measurements corresponding to respective regions are performed serially in time, a sufficient frame rate may not be ensured.

### SUMMARY

According to an aspect of the embodiments, there is provided a ranging device including: a counting unit configured to output a time count value indicating an elapsed time from a start of time counting; a control unit configured to control a light emission timing in a light emitting device divided into a plurality of emitting regions and a start timing of the time counting in the counting unit; a receiving unit including a plurality of pixels divided into a plurality of receiving regions so as to correspond one-to-one to the plurality of emitting regions, each of the plurality of pixels generating a light reception signal based on incident light in a measurement period from a light emission timing until a measurement ends in a corresponding emitting region and receiving region; a latch unit configured to generate a light reception time value indicating an elapsed time from the start of the time counting until the incident light is incident on any one of the plurality of receiving regions based on the time count value and a plurality of light reception signals respectively output from pixels in the plurality of receiving regions; and a calculation unit configured to calculate a flight time of light emitted from the light emitting device based on the light reception time value. Light emission timings of the plurality of emitting regions are different from each other, and a time difference between any two light emission timings of the plurality of emitting regions is shorter than a length of a measurement period in each of the plurality of receiving regions. The calculation unit calculates the flight time corresponding to each of the plurality of receiving regions based on the light reception time value and the time difference.

Further features of the disclosure will become apparent from the following description of exemplary embodiments with reference to the attached drawings.

### BRIEF DESCRIPTION OF THE DRAWINGS

FIG. 1 is a hardware block diagram illustrating a schematic configuration example of a ranging device according to a first embodiment.

FIG. 2 is a functional block diagram illustrating a schematic configuration example of the ranging device according to the first embodiment.

FIG. 3 is a diagram illustrating an outline of an operation of the ranging device in one ranging period according to the first embodiment.

FIGS. 4A, 4B, 4C, and 4D are histograms visually illustrating frequency distributions of pulse count values according to the first embodiment.

FIG. 5 is a block diagram illustrating a configuration example of a light receiving unit, a time counting unit, and a TOF value generation unit according to the first embodiment.

FIG. 6 is a block diagram illustrating a configuration example of a column processing unit according to the first embodiment.

FIG. 7 is a timing chart illustrating an operation example of the ranging device according to the first embodiment.

FIG. 8 is a timing chart illustrating an operation example of the ranging device according to a second embodiment.

FIG. 9 is a schematic view illustrating an overall configuration of a photoelectric conversion device according to a third embodiment.

FIG. 10 is a schematic block diagram illustrating a configuration example of a sensor substrate according to the third embodiment.

FIG. 11 is a schematic block diagram illustrating a configuration example of a circuit substrate according to the third embodiment.

FIG. 12 is a schematic block diagram illustrating a configuration example of one pixel of a photoelectric conversion unit and a pixel signal processing unit according to the third embodiment.

FIGS. 13A, 13B, and 13C are diagrams illustrating the operation of an avalanche photodiode according to the third embodiment.

FIGS. 14A and 14B are schematic diagrams of equipment according to a fourth embodiment.

### DESCRIPTION OF THE EMBODIMENTS

Embodiments of the present disclosure will now be described with reference to the accompanying drawings. In the drawings, the same or corresponding elements are denoted by the same reference numerals, and the description thereof may be omitted or simplified.

### First Embodiment

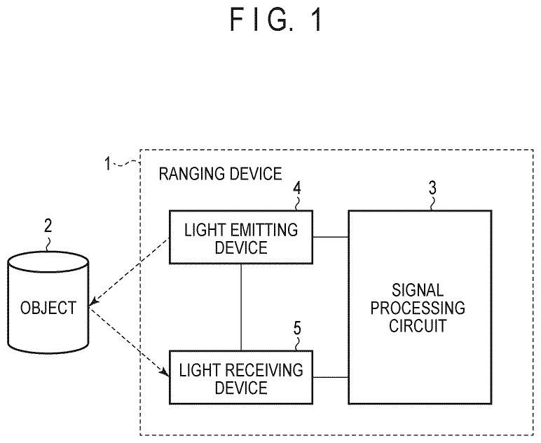

FIG. 1 is a hardware block diagram illustrating a schematic configuration example of a ranging device 1 according to the present embodiment. The ranging device 1 includes a signal processing circuit 3, a light emitting device 4, and a light receiving device 5. Note that the configuration of the ranging device 1 illustrated in the present embodiment is an example, and is not limited to the illustrated configuration.

The ranging device 1 is a device for measuring a distance to an object 2 of the ranging using a technology such as a light detection and ranging (LiDAR). The ranging device 1 measures a distance from the ranging device 1 to the object 2 based on a time difference until the light emitted from the light emitting device 4 is reflected by the object 2 and received by the light receiving device 5, that is, the time of flight (TOF) of the light. Further, the ranging device 1 can measure a plurality of points of distances in a two-dimensional manner by emitting laser light to a predetermined ranging range including the object 2 and receiving reflected light by the pixel array. Thus, the ranging device 1 can generate and output a distance image. Such a scheme is sometimes called a flash LiDAR.

The light received by the light receiving device 5 includes ambient light such as sunlight in addition to the reflected light from the object 2. For this reason, the ranging device 1 measures incident light in each of a plurality of periods (bin periods), and performs ranging in which influence of ambient light is reduced by using a method of determining that reflected light is incident in a period in which the amount of light peaks.

The light emitting device 4 is a device such as a semiconductor laser that emits light such as laser light to the outside of the ranging device 1. The signal processing circuit 3 may include a control circuit, a counter circuit, a processor that performs arithmetic processing of digital signals, a memory that stores digital signals, and the like. The memory may be, for example, a semiconductor memory.

The light receiving device 5 generates a pulse signal including a pulse based on the incident light. The light receiving device 5 is, for example, a photoelectric conversion device including an avalanche photodiode as a photoelectric conversion element. In this case, when one photon is incident on the avalanche photodiode and a charge is generated, one pulse is generated by avalanche multiplication. However, the light receiving device 5 may include, for example, a photoelectric conversion element using another photodiode. The light receiving device 5 includes a plurality of photoelectric conversion elements, and can output a signal indicating an address of the photoelectric conversion element into which a photon is incident.

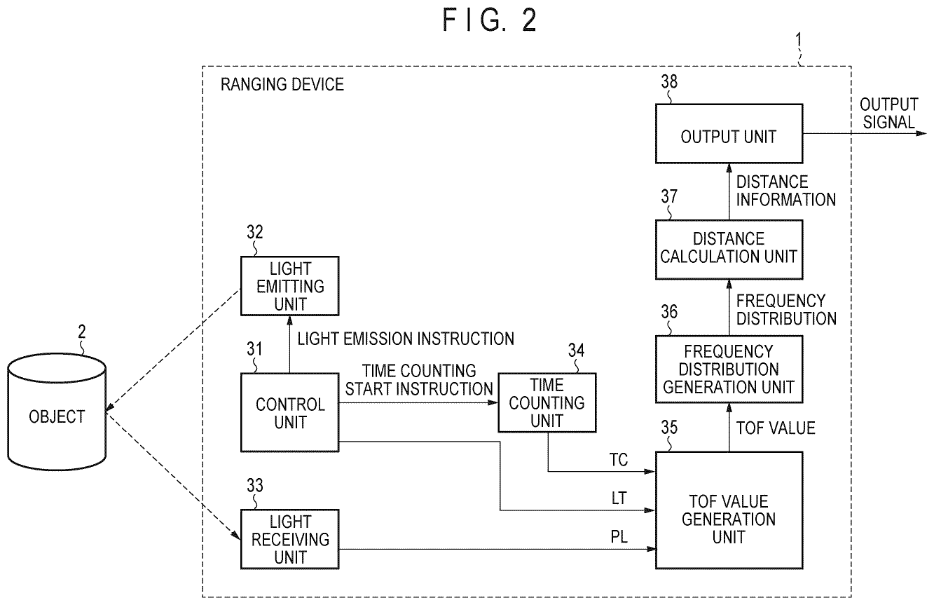

FIG. 2 is a functional block diagram illustrating a schematic configuration example of the ranging device 1 according to the present embodiment. The ranging device 1 includes a control unit 31, a light emitting unit 32, a light receiving unit 33, a time counting unit 34, a TOF value generation unit 35, a frequency distribution generation unit 36, a distance calculation unit 37, and an output unit 38. The light emitting unit 32 and the light receiving unit 33 correspond to the light emitting device 4 and the light receiving device 5 in FIG. 1, respectively. The control unit 31, the time counting unit 34, the TOF value generation unit 35, the frequency distribution generation unit 36, the distance calculation unit 37, and the output unit 38 correspond to the signal processing circuit 3 in FIG. 1.

The light emitting unit 32 includes a plurality of light emitting elements. The light emitting unit 32 emits light such as laser light within a predetermined area of ranging. The light emitting unit 32 is divided into a plurality of light emitting regions, and each light emitting region can operate independently.

The control unit 31 outputs a control signal instructing light emission to the light emitting unit 32, thereby controlling the light emission timing of each of the plurality of light emitting regions of the light emitting unit 32. The emission timing of each of the plurality of emitting regions may be controlled to be different from each other. Further, the control unit 31 outputs a control signal instructing the start timing of the time counting to the time counting unit 34. Thereby, the time counting unit 34 starts time counting. The control unit 31 performs synchronization control of the entire ranging device 1 in the ranging frame period. As a result, the control unit 31 performs synchronous control of the start of time counting and the light emission of the light emitting unit 32 performed a plurality of times in one frame period. Further, the control unit 31 generates a light emission time latch signal LT corresponding to the light emission timing of each light emitting region, and outputs the light emission time latch signal LT to the TOF value generation unit 35.

The time counting unit 34 performs time counting based on the control of the control unit 31 to generate a time count value TC indicating an elapsed time from the time at which counting is started. The time counting unit 34 outputs the time count value TC to the TOF value generation unit 35. The time counting unit 34 includes, for example, a circuit such as a ring oscillator and a counter, and counts a clock pulse that vibrates at high speed and at a constant period, thereby performing time counting.

The light emitted from the light emitting unit 32 is reflected by the object 2 that is a ranging object. The light receiving unit 33 receives light including reflected light from the object 2. The light receiving unit 33 generates a pulse of an electric signal based on the incident light, and outputs the pulse as a light reception pulse PL (light reception signal) to the TOF value generation unit 35. The light receiving unit 33 includes a plurality of pixels each including a photoelectric conversion element. The plurality of pixels is divided into a plurality of light receiving regions. The plurality of light receiving regions of the light receiving unit 33 are divided so as to correspond to the plurality of light emitting regions of the light emitting unit 32 one by one.

The TOF value generation unit 35 generates a TOF value based on the time count value TC, the light emission time latch signal LT, and the light reception pulse PL that are input, and outputs a TOF value to the frequency distribution generation unit 36. Here, the TOF value is a value indicating a flight time of light from light emission to light reception. The configuration and operation of the TOF value generation unit 35 will be described later.

The generated TOF value is accumulated in the form of a frequency distribution in the frequency distribution generation unit 36. The frequency distribution is information in which a class being set at a predetermined time interval is associated with a frequency of the light reception pulse PL based on the incident light in a period corresponding to each class. The frequency distribution generation unit 36 includes a memory for storing a frequency distribution. When the frequency distribution for one distance measurement frame is accumulated in the frequency distribution generation unit 36, the distance calculation unit 37 calculates distance information from the frequency distribution. The output unit 38 outputs the calculated distance information to the outside.

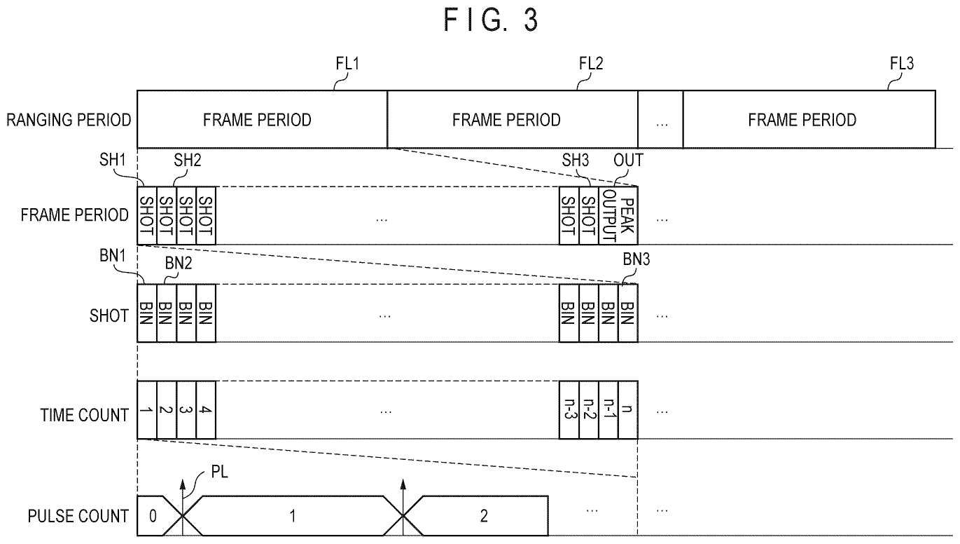

FIG. 3 is a diagram illustrating an outline of the operation of the ranging device 1 according to the present embodiment in one ranging period. In the “ranging period” of FIG. 3, a plurality of frame periods FL1, FL2, . . . , FL3 included in one ranging period are illustrated. The frame period FL1 indicates the first frame period in one ranging period, the frame period FL2 indicates the second frame period in one ranging period, and the frame period FL3 indicates the last frame period in one ranging period. The frame period is a period in which the ranging device 1 performs ranging once and outputs a signal indicating a distance (ranging result) from the ranging device 1 to the object 2 to the outside once.

In the “frame period” of FIG. 3, a plurality of shots SH1, SH2, . . . , SH3 included in the frame period FL1 and a peak output OUT are illustrated. The shot is a period in which the light emitting unit 32 emits light and the frequency distribution is updated by the light reception pulse PL based on the light emission. The shot SH1 indicates the first shot in the frame period FL1. The Shot SH2 indicates the second shot in the frame period FL1. The shot SH3 indicates the last shot in the frame period FL1. The peak output OUT indicates a period in which ranging result is output based on a peak obtained by accumulating signals of the plurality of shots.

In the “shot” of FIG. 3, a plurality of bins BN1, BN2, . . . , BN3 included in the shot SH1 are illustrated. The “bin” indicates one time interval (bin period) in which a series of pulse counting is performed and pulse counting is performed. The bin BN1 indicates the first bin in the shot SH1. The bin BN2 indicates the second bin in the shot SH1. The bin BN3 indicates the last bin in the shot SH1.

The “time count” in FIG. 3 schematically illustrates a temporal change of the time count value generated in the time counting unit 34. As illustrated in FIG. 3, the time counting unit 34 counts up the count value in accordance with the elapse of time. Therefore, the time count value is a parameter for determining a bin number.

The “pulse count” in FIG. 3 schematically illustrates a pulse based on the incident light in the bin BN1 and a change in the pulse count value of the bin BN1. As illustrated in FIG. 3, when the light reception pulse PL rises, the pulse count value increases by one. Thus, the number of photons detected within the bin period is acquired as a pulse count value. When one bin period has elapsed and the next bin period has arrived, the pulse count value is reset to zero.

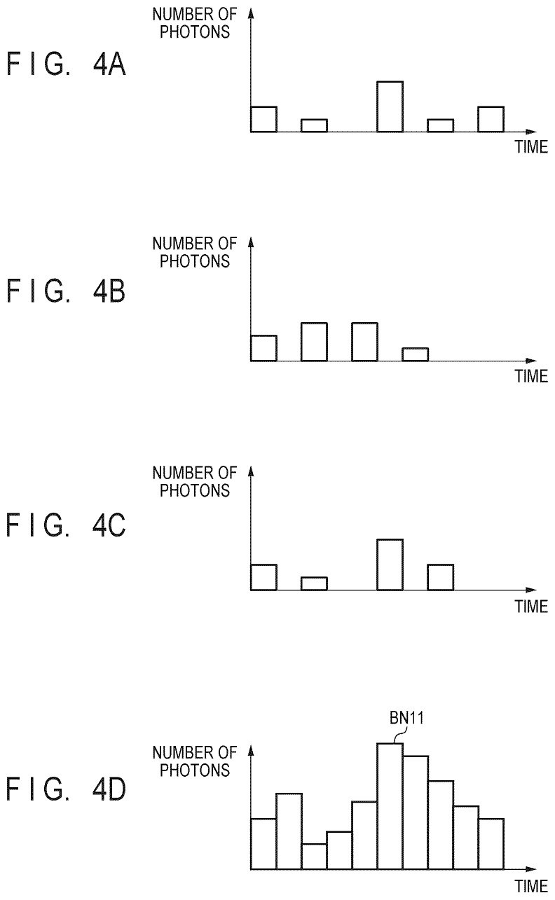

FIGS. 4A to 4D are histograms visually illustrating frequency distributions generated by the frequency distribution generation unit 36. In the present specification, the frequency distribution is frequency information corresponding to a predetermined class width, and is not necessarily displayed visually. FIGS. 4A, 4B, and 4C illustrate examples of histograms of the numbers of photons (corresponding to pulse count values) in the first shot, the second shot, and the third shot, respectively. FIG. 4D illustrates an example of a histogram obtained by accumulating the number of photons of all shots. The horizontal axis represents the elapsed time from light emission. A section of the histogram corresponds to a period of one bin in which photon detection is performed. The vertical axis represents the number of photons detected in each bin period. Thus, the histogram includes first information (horizontal axis) on time and second information (vertical axis) on the number of pulses. Specifically, the first information includes, for example, the start time of the time interval of the bin, the end time of the time interval of the bin, and the width (resolution) of the time interval of the bin. On the other hand, the second information is, for example, the number of pulses detected within the time interval of each bin. Similarly, the frequency distribution also includes first information on time and second information on the number of pulses.

As illustrated in FIG. 4A, in the first shot, photons are incident in five bin periods. As illustrated in FIG. 4B, in the second shot, photons are incident in four bin periods. As illustrated in FIG. 4C, photons are incident in four bin periods also in the third shot. Thus, the number of incident photons and the incident time are different in each shot. These frequency distributions may include not only the reflected light from the object 2, but also frequency due to pulse count values by ambient light other than the reflected light.

As illustrated in FIG. 4D, in the histogram obtained by accumulating the number of photons of all shots, the sixth bin BN11 is a peak. In the peak output OUT illustrated in FIG. 3, the time information of the bin corresponding to the peak of the frequency distribution after the accumulation is output. The time information indicates the flight time of the reflected light from the object 2, and can be used to calculate the distance between the ranging device 1 and the object 2.

By integrating the pulse count values of a plurality of shots, even when a pulse count value due to ambient light can be included, a bin that is likely to include a pulse count value due to reflected light from the object 2 can be detected with higher accuracy. Therefore, even when the light emitted from the light emitting unit 32 is weak, a plurality of shots is repeated, and by employing processing of accumulating these shots, the ranging can be performed with high accuracy.

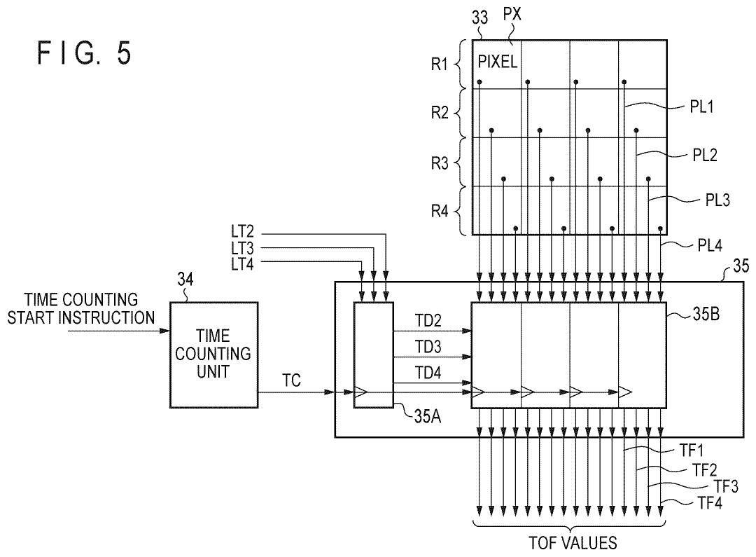

Next, the configurations of the light receiving unit 33, the time counting unit 34, and the TOF value generation unit 35 will be described in detail with reference to FIG. 5. FIG. 5 is a block diagram illustrating a configuration example of the light receiving unit 33, the time counting unit 34, and the TOF value generation unit 35 according to the present embodiment.

As illustrated in FIG. 5, the light receiving unit 33 includes a plurality of pixels PX arranged to form a plurality of rows and a plurality of columns. As described above, the light receiving unit 33 is divided into a plurality of light receiving regions. In the example of FIG. 5, the light receiving unit 33 is divided into four light receiving regions R1, R2, R3, and R4. Each of the light receiving regions R1, R2, R3, and R4 includes a plurality of pixels PX. A plurality of pixels PX belonging to the same light receiving region are controlled collectively, and a plurality of pixels PX belonging to different light receiving regions are controlled individually. In other words, the light receiving regions R1, R2, R3, and R4 represent units of control of the light receiving unit 33. As described above, the plurality of light receiving regions of the light receiving unit 33 are divided so as to correspond one-to-one to the plurality of light emitting regions of the light emitting unit 32. Therefore, it is assumed that the light emitting unit 32 is also divided into four light emitting regions respectively corresponding to the four light receiving regions R1, R2, R3, and R4.

FIG. 5 illustrates an example in which the first, second, third, and fourth rows in the light receiving unit 33 are light receiving regions R1, R2, R3, and R4, respectively, and one row of the light receiving unit 33 corresponds to one light receiving region. However, this configuration is merely an example, and the method of setting the light receiving regions applicable to the present embodiment is not limited thereto. Although FIG. 5 illustrates an example in which 16 pixels PX are arranged in four rows and four columns, this is only an example, and the number of rows, the number of columns, and the number of pixels are not limited to those illustrated in FIG. 5.

The TOF value generation unit 35 includes a time difference generation unit 35A and a plurality of column processing units 35B. The time count value TC is input from the time counting unit 34 to the time difference generation unit 35A, and the light emission time latch signals LT2, LT3, and LT4 are input from the control unit 31 to the time difference generation unit 35A. Here, the light emission time latch signals LT2, LT3, and LT4 (light emission time signals) are signals indicating light emission times in three light emitting regions (light emitting regions other than the reference light emitting region) corresponding to the light receiving regions R2, R3, and R4, respectively. As described later, the reference time of the time count value TC coincides with the light emitting time of the light emitting region (reference light emitting region) corresponding to the light receiving region R1. Therefore, since the light emission time latch signal indicating the light emission time in the light emitting regions corresponding to the light receiving regions R1 is not required for processing in the time difference generation unit 35A, the processing is simplified.

The time difference generation unit 35A generates time difference values TD2, TD3, and TD4 by latching the time count value TC at the time when the light emission time latch signals LT2, LT3, and LT4 are input, and outputs the time difference values TD2, TD3, and TD4 to the plurality of column processing units 35B. Here, the time difference value TD2 is a value indicating a time difference between the light emitting time in the light emitting region corresponding to the light receiving region R2 and the light emitting time in the light emitting region corresponding to the light receiving region R1. The time difference value TD3 is a value indicating a time difference between the light emitting time in the light emitting region corresponding to the light receiving region R3 and the light emitting time in the light emitting region corresponding to the light receiving region R1. The time difference value TD4 is a value indicating a time difference between the light emitting time in the light emitting region corresponding to the light receiving region R4 and the light emitting time in the light emitting region corresponding to the light receiving region R1.

The column processing unit 35B is arranged to correspond to each column of the plurality of pixels PX. The time count value TC, the time difference values TD2, TD3, and TD4, and light reception pulses PL1, PL2, PL3, and PL4 are input to the column processing unit 35B. The light reception pulses PL1, PL2, PL3, and PL4 are light reception pulses output from the pixels PX arranged in the corresponding columns of the light receiving regions R1, R2, R3, and R4, respectively. The column processing unit 35B generates TOF values TF1, TF2, TF3, and TF4 in the light receiving regions R1, R2, R3, and R4 based on these input signals. The TOF values TF1, TF2, TF3, and TF4 are output to the frequency distribution generation unit 36.

When the incident light is detected, the frequency distribution generation unit 36 generates a frequency distribution by repeating the processing of accumulating the frequency of the bin of the bin number corresponding to the magnitude of the TOF value for each shot.

As described above, the time difference generation unit 35A and the plurality of column processing units 35B perform processing by referring to the same time count value TC output from the same time counting unit 34. The column processing unit 35B is shared by the pixels PX of the light receiving regions R1, R2, R3, and R4 in one column. As described above, in the present embodiment, the time counting unit 34 and the TOF value generation unit 35 are shared by the plurality of light receiving regions R1, R2, R3, and R4 of the light receiving unit 33. Therefore, the circuit scale can be reduced.

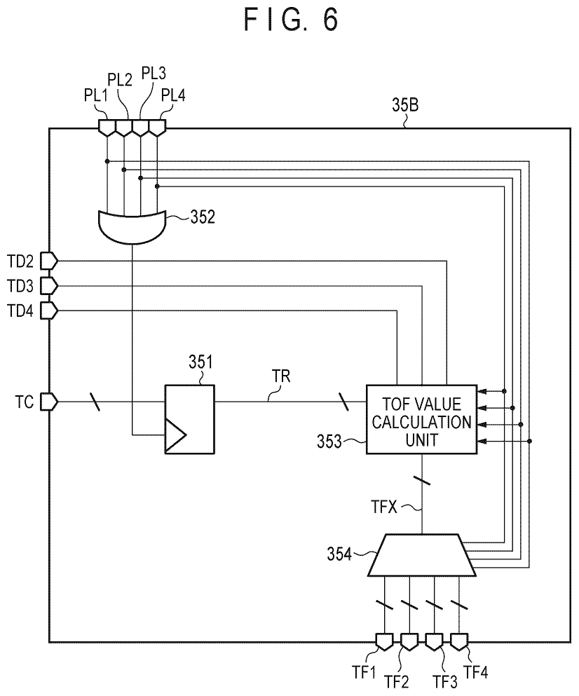

Next, the configuration of the column processing unit 35B will be described in detail with reference to FIG. 6. FIG. 6 is a block diagram illustrating a configuration example of a column processing unit 35B according to the present embodiment. FIG. 6 illustrates a configuration of one column out of the plurality of column processing units 35B in FIG. 5.

The column processing unit 35B includes a time latch unit 351, an OR circuit 352, a TOF value calculation unit 353, and a selection circuit 354. The light reception pulses PL1, PL2, PL3, and PL4 output from the pixel PX are input to the OR circuit 352, the TOF value calculation unit 353, and the selection circuit 354. The time count value TC output from the time counting unit 34 is input to the time latch unit 351. The time difference values TD2, TD3, and TD4 output from the time difference generation unit 35A are input to the TOF value calculation unit 353.

The OR circuit 352 is a logic circuit that outputs the logical sum of the light reception pulses PL1, PL2, PL3, and PL4 to the time latch unit 351 as a latch signal. The time latch unit 351 latches the value of the time count value TC at a time when a high-level pulse indicating light reception is input from any one of the light reception pulses PL1, PL2, PL3, and PL4. Then, the time latch unit 351 outputs the latched time count value TC to the TOF value calculation unit 353 as the light reception time value TR. The light reception time value TR indicates an elapsed time from the start of time counting until light is incident on any one of the plurality of light receiving regions R1, R2, R3, and R4.

The TOF value calculation unit 353 calculates the TOF value TFX before selection based on the light reception time value TR, the time difference values TD2, TD3, and TD4 and the light reception pulses PL1, PL2, PL3, and PL4. The TOF value TFX is a TOF value corresponding to one of the light receiving regions R1, R2, R3, and R4 selected corresponding to the light reception pulses PL1, PL2, PL3, and PL4. The TOF value TFX is input to the selection circuit 354.

The selection circuit 354 outputs the TOF value TFX to the output terminals selected based on the light reception pulses PL1, PL2, PL3, and PL4 as the TOF values TF1, TF2, TF3, and TF4. Thus, the selection circuit 354 can distribute and output the TOF value TFX to an appropriate terminal corresponding to the light receiving region where the light reception has occurred. However, the selection circuit 354 may perform exception processing such as not outputting the TOF value to any of the output terminals when light reception occurs at the same time in a plurality of light receiving regions.

The TOF value calculation unit 353 determines which of the light reception pulses PL1, PL2, PL3, and PL4 the input light reception pulse is, and performs different processing. When the light reception pulse PL2 is input, the TOF value calculation unit 353 subtracts the corresponding time difference value TD2 from the light reception time value TR and outputs it as the TOF value TFX. Similarly, when the light reception pulse PL3 or the light reception pulse PL4 is input, the TOF value calculation unit 353 subtracts the corresponding time difference value TD3 or the corresponding time difference value TD4 from the light reception time value TR and outputs it as the TOF value TFX. On the other hand, when the light reception pulse PL1 is input, the TOF value calculation unit 353 outputs the light reception time value TR as it is as the TOF value TFX. Since the start time of the count of the time count value TC coincides with the light emission time corresponding to the light reception pulse PL1, the subtraction processing for the light reception time value TR corresponding to the light reception pulse PL1 is unnecessary.

As described above, the column processing unit 35B can calculate the TOF value by referring to the time count value TC output from one time counting unit 34 even when the light emission timing is different for each light emitting region. Therefore, the number of input signals is reduced and the circuit is simplified. However, the configuration of the column processing unit 35B is not limited to that illustrated in FIG. 6.

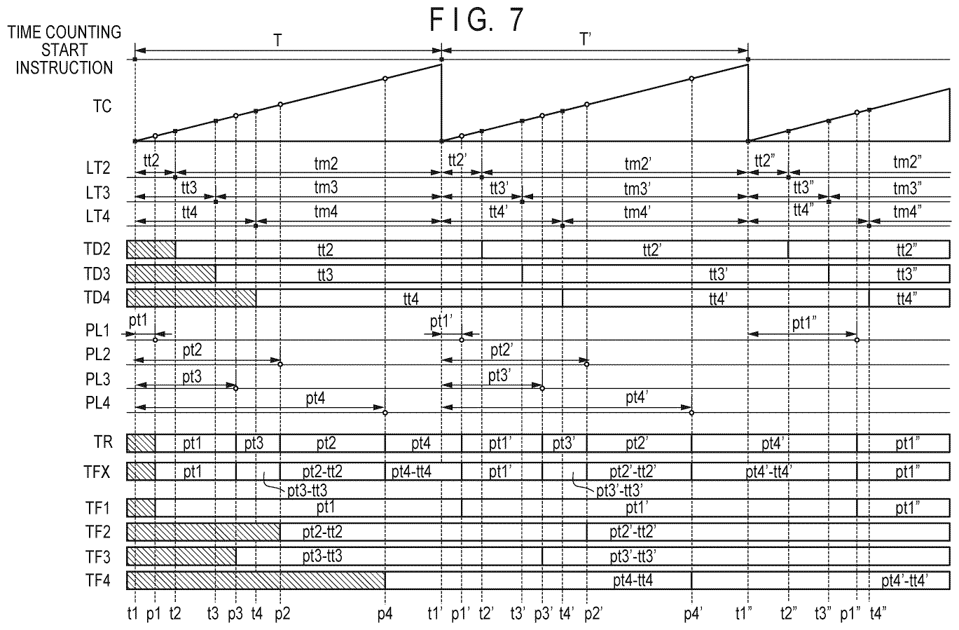

Next, the operation of the ranging device 1 will be described in detail with reference to FIG. 7. FIG. 7 is a timing chart illustrating an operation example of the ranging device according to the present embodiment. FIG. 7 illustrates an operation related to signal acquisition from the pixels PX of one column.

FIG. 7 illustrates an example of the timing of the time counting start instruction, the timing of the light emission time latch signals LT2, LT3, and LT4, the timing of the light reception pulses PL1, PL2, PL3, and PL4, and the temporal change of the time count value TC. FIG. 7 illustrates examples of temporal changes of the time difference values TD2, TD3, and TD4, the light reception time value TR, and the TOF values TFX, TF1, TF2, TF3, and TF4. The horizontal axis of FIG. 7 represents elapsed time, and a period T, which is an interval of the time counting start instruction, corresponds to a period of one shot in FIG. 3.

At time t1 at which the processing of the first shot (first measurement period) starts, the light emitting region corresponding to the light receiving region R1 emits light, and at the same time, a control signal of a time counting start instruction is output. Thereby, the time counting unit 34 starts time counting, and the time count value TC starts increasing. The light emitting region that emits light at the time t1 is a light emitting region that emits light at the earliest time among the plurality of light emitting regions.

At times t2, t3, and t4, the light emitting regions corresponding to the light receiving regions R2, R3, and R4 emit light, respectively. Accordingly, at the times t2, t3, and t4, the control unit 31 outputs the light emission time latch signals LT2, LT3, and LT4. At the times t2, t3, and t4, the time difference generation unit 35A generates time difference values TD2, TD3, and TD4 by referring to the time count value TC at the corresponding time. These time difference values are tt2, tt3, and tt4, respectively. The time difference value tt2 corresponds to a time difference between the time t2 and the time 1. The time difference value tt3 corresponds to a time difference between the time t3 and the time 1. The time difference value tt4 corresponds to a time difference between the time t4 and the time 1.

The measurement period in which measurement can be performed in each of the light receiving regions R1, R2, R3, and R4 is from the emission time of the corresponding light emitting region to the end of the measurement. Accordingly, the measurement period of the light receiving region R1 is the entire period T. The measurement periods of the light receiving regions R2, R3, and R4 are the periods tm2, tm3, and tm4 after the times t2, t3, and t4, respectively. Thus, in the present embodiment, part of the measurement periods of the light receiving regions R1, R2, R3, and R4 overlap each other. Since the time difference between two of the times t1, t2, t3, and t4 which are light emission times is shorter than one of the measurement periods of R1, R2, R3, and R4 of the light receiving region, such overlap of the measurement periods occurs.

Times p1, p2, p3, and p4 are the times at which photons are detected in the pixels PX of the light receiving regions R1, R2, R3, and R4, respectively. At the times p1, p2, p3, and p4, the pixels PX of the light receiving regions R1, R2, R3, and R4 output light reception pulses PL1, PL2, PL3, and PL4, respectively. The time latch unit 351 updates the light reception time value TR by referring to the time count value at these times. The light reception time value TR corresponds to a time difference from the time t1 to any one of the times p1, p2, p3, and p4. These light reception time values are denoted by pt1, pt2, pt3, and pt4, respectively.

At the time p1, the TOF value calculation unit 353 outputs a TOF value TFX having a value pt1 corresponding to the light reception time value pt1 to the selection circuit 354. The selection circuit 354 outputs the TOF value TF1 having the value pt1 to the frequency distribution generation unit 36.

At the time p3, the TOF value calculation unit 353 outputs a TOF value TFX having a value pt3-tt3 obtained by subtracting the time difference value tt3 from the light reception time value pt3 to the selection circuit 354. The selection circuit 354 outputs the TOF value TF3 having the value pt3-tt3 to the frequency distribution generation unit 36.

At the time p2, the TOF value calculation unit 353 outputs a TOF value TFX having a value pt2-tt2 obtained by subtracting the time difference value tt2 from the light reception time value pt2 to the selection circuit 354. The selection circuit 354 outputs the TOF value TF2 having the value pt2-tt2 to the frequency distribution generation unit 36.

At the time p4, the TOF value calculation unit 353 outputs a TOF value TFX having a value pt4-tt4 obtained by subtracting the time difference value tt4 from the light reception time value pt4 to the selection circuit 354. The selection circuit 354 outputs the TOF value TF4 having the value pt4-tt4 to the frequency distribution generation unit 36.

The time t1′ is a time at which a control signal of a time counting start instruction corresponding to the second shot (second measurement cycle) which is the next shot of the first shot is output. Also, at the time t1′, similarly to the time t1, the light emitting region corresponding to the light receiving region R1 emits light. In FIG. 7, in order to distinguish the second shot from the first shot, reference characters associated with the second shot are denoted by <′>. Reference characters associated with the third shot, which is the next shot of the second shot, are denoted by <″>. Since the operation after the second shot is substantially the same as the operation of the first shot, the description thereof will be omitted. The interval between the time t1′ and the time t4 that is the last light emission time is set such that the time required for measurement is ensured in the pixel PX of the light receiving region R4 corresponding to the time t4. In other words, after all of the plurality of light receiving regions R1, R2, R3, and R4 complete the measurement in the first shot, the first light emission in the second shot is performed.

According to the present embodiment, in the ranging device 1 having the light emitting device divided into the plurality of light emitting regions and the plurality of light receiving regions corresponding to the plurality of light emitting regions one-to-one, part of the measurement periods of the plurality of light receiving regions overlap each other. Thus, the processing time can be shortened and the frame rate can be improved as compared with the case where the measurement periods of the plurality of light receiving regions do not overlap. Therefore, according to the present embodiment, the ranging device 1 capable of improving the frame rate is provided.

Further, since the emission timings of the plurality of light emitting regions are different from each other, the instantaneous maximum value of the emission intensity is reduced as compared with the case where the plurality of light emitting regions emit light at the same time. Thereby, the emission intensity of each light emitting region can be increased while satisfying the eye safety standard, and the ranging quality can be improved.

The time counting unit 34 and the TOF value generation unit 35 are shared by the plurality of light receiving regions R1, R2, R3, and R4 of the light receiving unit 33. Therefore, the circuit scale can be reduced as compared with the case where those units are individually arranged for each of the light receiving regions R1, R2, R3, and R4.

Further, the TOF value generation unit 35 measures the time difference values tt2, tt3, and tt4 corresponding to the light emission intervals of the respective light receiving regions based on the light emission time latch signals LT2, LT3, and LT4 and the light reception pulses PL1, PL2, PL3, and PL4. Thus, for example, even when the TOF value generation unit 35 cannot directly acquire the information of the light emission interval due to a factor such as a control of changing the light emission timing in a short time, the TOF value generation unit 35 can measure and acquire the information of the light emission interval, and the information can be used for generation of the TOF value. However, the setting value of the light emission timing control may be held in the TOF value generation unit 35 in advance, and in this case, the measurement of the time difference values tt2, tt3, and tt4 may be omitted and the setting value may be used as it is for the TOF value calculation.

In addition, in the plurality of light emitting regions of the light emitting unit 32, two light emitting regions which continuously emit light may be in a positional relationship that is not adjacent to each other in a plan view. In this case, even if the two adjacent light emitting regions have a positional relationship in which emitted lights from the two adjacent light emitting regions can both enter one eye of a person, it is possible to reduce the possibility that a plurality of emitted lights enter the eye at a short time interval, thereby improving the effect of eye safety.

Further, in the plurality of light emitting regions of the light emitting unit 32, the light emitting order of each light emitting region may be random. In this case, the measurement period in each light receiving region is random. It is assumed that two ranging devices 1 are arranged so as to face each other. In this case, a false TOF value may be detected by the light emitted from one ranging device 1 entering the other ranging device 1. By randomizing the light emitting order of each light emitting region, the false TOF value due to the light emitted from the other ranging device 1 varies, and the false TOF value is less likely to be accumulated in the same bin on the frequency distribution. Therefore, the possibility of erroneous determination of the ranging result based on the false TOF value as described above can be reduced.

### Second Embodiment

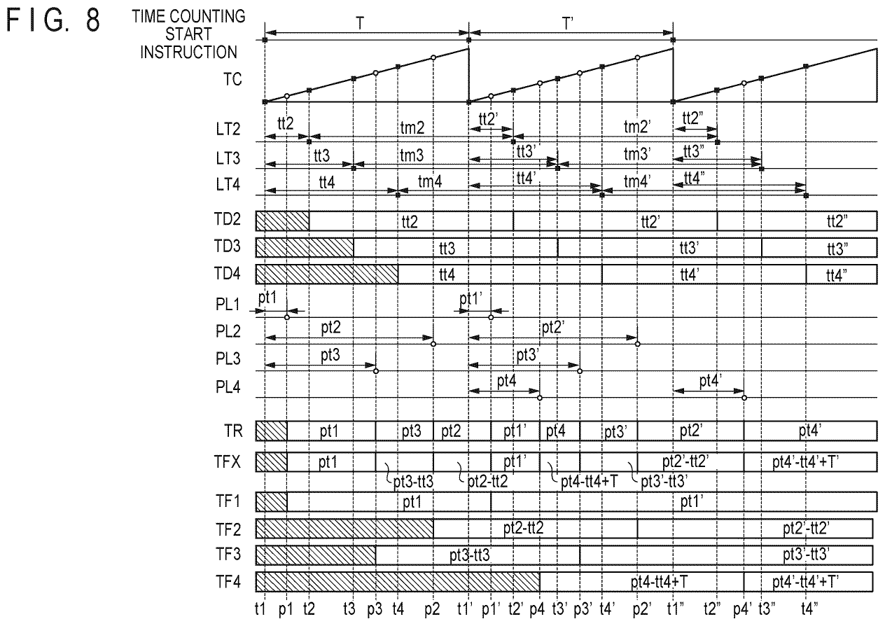

The ranging device 1 according to the second embodiment will be described with reference to FIGS. 6 and 8. In the description of the present embodiment, the description of elements common to those of the first embodiment may be omitted or simplified. In the first embodiment, the light emission for the next measurement is performed after the completion of the measurement of the entire light receiving area, but in the present embodiment, the light emission for the next measurement is performed without waiting for the completion of the measurement of the entire light receiving area. Note that the configuration illustrated below is merely an example, and the processing performed by the ranging device 1 is not limited to the following configuration.

First, with reference to FIG. 6 again, with respect to the operation of the TOF value generation unit 35, portions different from the first embodiment will be described. In the present embodiment, the TOF value calculation unit 353 compares the magnitude relationship between the light reception time value TR and each of the time difference values TD2, TD3, and TD4. Then, different calculation processing is performed depending on whether or not the light reception time value TR is equal to or greater than the time difference.

First, a case where the light reception pulse PL2 is input will be described. When the light reception time value TR is equal to or greater than the time difference value TD2, the TOF value calculation unit 353 subtracts the corresponding time difference value TD2 from the light reception time value TR, and outputs it as the TOF value TFX. This is the same calculation processing as in the first embodiment. When the light reception time value TR is less than the time difference value TD2, the TOF value calculation unit 353 subtracts the corresponding time difference value TD2 from the light reception time value TR, adds the upper limit value of the time count value (the value immediately before the reset of the time count value), and outputs the resultant TOF value TFX.

A case where the light reception pulse PL3 is input will be described. When the light reception time value TR is equal to or greater than the time difference value TD3, the TOF value calculation unit 353 subtracts the corresponding time difference value TD3 from the light reception time value TR, and outputs it as the TOF value TFX. When the light reception time value TR is less than the time difference value TD3, the TOF value calculation unit 353 subtracts the corresponding time difference value TD3 from the light reception time value TR, adds the upper limit value of the time count value (the value immediately before the time count value is reset), and outputs the resultant TOF value TFX.

A case where the light reception pulse PL4 is input will be described. When the light reception time value TR is equal to or greater than the time difference value TD4, the TOF value calculation unit 353 subtracts the corresponding time difference value TD4 from the light reception time value TR, and outputs it as the TOF value TFX. When the light reception time value TR is less than the time difference value TD4, the TOF value calculation unit 353 subtracts the corresponding time difference value TD4 from the light reception time value TR, adds the upper limit value of the time count value (a value immediately before the time count value is reset), and outputs the resultant TOF value TFX.

The processing performed when the light reception pulse PL1 is input is similar to that in the first embodiment. That is, the TOF value calculation unit 353 outputs the light reception time value TR as it is as the TOF value TFX.

The TOF value calculation unit 353 can acquire the upper limit value of the time count value by detecting the reset of the time count value and storing the value immediately before the reset. The upper limit value of the time count value may be input from the time counting unit 34 to the TOF value calculation unit 353.

Next, the operation of the ranging device 1 will be described in detail with reference to FIG. 8. FIG. 8 is a timing chart illustrating an operation example of the ranging device according to the present embodiment. FIG. 8 illustrates an operation related to signal acquisition from the pixels PX of one column.

In the present embodiment, the times t1′, t2′, t3′, and t4′, which are the emission timings of the second shot, and the times t1″, t2″, t3″, and t4″, which are the emission timings of the third shot, are changed to times earlier than those in the first embodiment. Further, in the present embodiment, the measurement period in which measurement can be performed in each of the light receiving regions R1, R2, R3, and R4 is from the emission time of the corresponding light emitting region to the next emission time. That is, the measurement period of the light receiving region R1 is the entire period T. The measurement periods of the light receiving regions R2, R3, and R4 are the periods tm2, tm3, and tm4 after the times t2, t3, and t4, respectively. In the first embodiment, control is performed such that the measurement periods (periods T, tm2, tm3, and tm4 in FIG. 7) are longer in the light receiving region corresponding to the light emitting region whose light emitting time is earlier. On the other hand, in the present embodiment, since the lengths of the measurement periods (periods T, tm2, tm3, and tm4 in FIG. 8) of the light receiving regions R1, R2, R3, and R4 can be made substantially the same, the entire measurement period is shortened.

In the present embodiment, since a part of the measurement period overlaps the period after the light emission of the next shot, the light reception may be detected after the count value is reset. The time p4 in FIG. 8 illustrates an example of such a case. That is, in FIG. 8, the reflected light of the light emitted at the time t4 is received at the time p4 after the time t1′ at which the count value is reset.

At the time p4, the TOF value calculation unit 353 subtracts the time difference value tt4 from the light reception time value pt4 and adds the value T of the time count value TC immediately before the reset corresponding to the length of the period T. The TOF value calculation unit 353 outputs the TOF value TFX having the value pt4-tt4+T obtained by this calculation processing to the selection circuit 354. The selection circuit 354 outputs the TOF value TF4 having the value pt4-tt4+T to the frequency distribution generation unit 36. By this calculation processing, since the obtained value pt4-tt4+T corresponds to the elapsed time between the time t4 and the time p4, an appropriate TOF value is output by this processing.

According to the present embodiment, the ranging device 1 capable of obtaining the same effect as in the first embodiment is provided. Further, since the ranging device 1 of the present embodiment can emit light for the next measurement without waiting for the completion of the measurement of all the light receiving regions, the frame rate can be improved as compared with the ranging device 1 of the first embodiment.

### Third Embodiment

In the present embodiment, a specific configuration example of a photoelectric conversion device that includes an avalanche photodiode and that can be applied to the ranging device 1 according to the first and second embodiments will be described. The configuration example of the present embodiment is an example, and the photoelectric conversion device applicable to the ranging device 1 is not limited thereto.

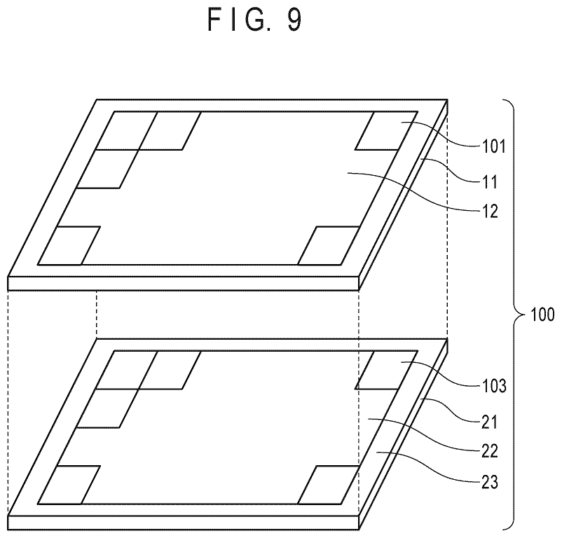

FIG. 9 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing units 103 are arranged to form a plurality of rows and a plurality of columns, and a second circuit region 23 arranged outside the first circuit region 22. The second circuit region 23 may include a circuit for controlling the plurality of pixel signal processing units 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

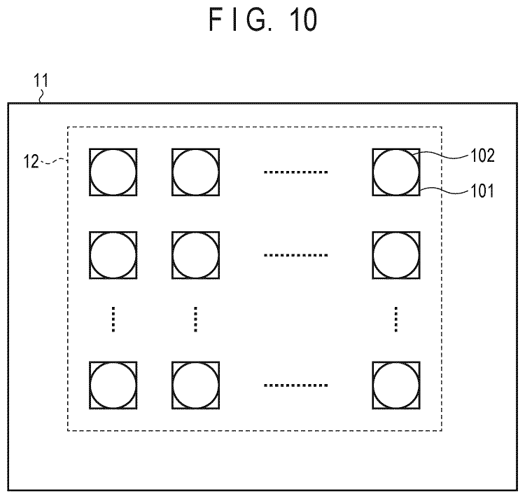

FIG. 10 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

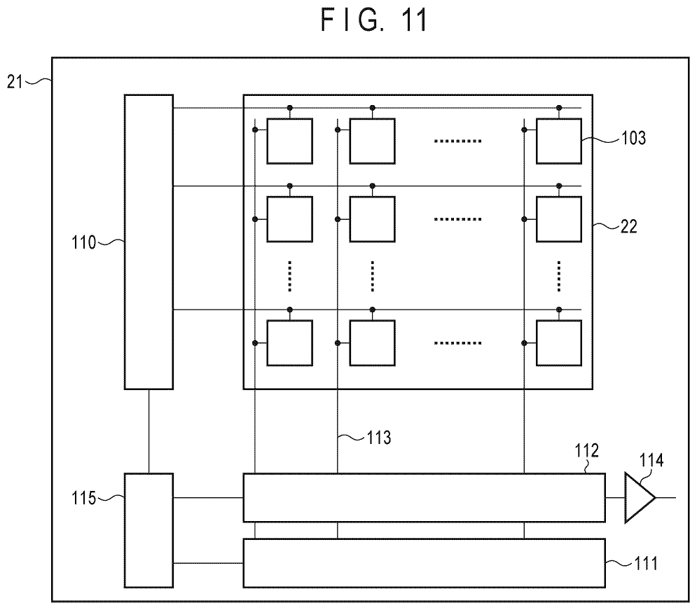

FIG. 11 is a schematic block diagram illustrating a configuration example of the circuit substrate 21. The circuit substrate 21 has the first circuit region 22 in which a plurality of pixel signal processing units 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit 115. The plurality of photoelectric conversion units 102 illustrated in FIG. 10 and the plurality of pixel signal processing units 103 illustrated in FIG. 11 are electrically connected to each other via connection wirings provided for each pixels 101.

The control signal generation unit 115 is a control circuit that generates control signals for driving the vertical scanning circuit 110, the horizontal scanning circuit 111, and the reading circuit 112, and supplies the control signals to these units. As a result, the control signal generation unit 115 controls the driving timings and the like of each unit.

The vertical scanning circuit 110 supplies control signals to each of the plurality of pixel signal processing units 103 based on the control signal supplied from the control signal generation unit 115. The vertical scanning circuit 110 supplies control signals for each row to the pixel signal processing unit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing unit 103.

The signal output from the photoelectric conversion unit 102 of the pixel 101 is processed by the pixel signal processing unit 103. The pixel signal processing unit 103 counts the number of pulses output from the APD included in the photoelectric conversion unit 102 to acquire and hold a digital signal.

It is not always necessary to provide one pixel signal processing unit 103 for each of the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

The horizontal scanning circuit 111 supplies control signals to the reading circuit 112 based on a control signal supplied from the control signal generation unit 115. The pixel signal processing unit 103 is connected to the reading circuit 112 via a pixel output signal line 113 provided for each column of the first circuit region 22. The pixel output signal line 113 in one column is shared by a plurality of pixel signal processing units 103 in the corresponding column. The pixel output signal line 113 includes a plurality of wirings, and has at least a function of outputting a digital signal from the pixel signal processing unit 103 to the reading circuit 112, and a function of supplying a control signal for selecting a column for outputting a signal to the pixel signal processing unit 103. The reading circuit 112 outputs a signal to an external storage unit or signal processing unit of the photoelectric conversion device 100 via the output circuit 114 based on the control signal supplied from the control signal generation unit 115.

The arrangement of the photoelectric conversion units 102 in the pixel region 12 may be one-dimensional. Further, the function of the pixel signal processing unit 103 does not necessarily have to be provided one by one in all the pixels 101. For example, one pixel signal processing unit 103 may be shared by a plurality of pixels 101. In this case, the pixel signal processing unit 103 sequentially processes the signals output from the photoelectric conversion units 102, thereby providing the function of signal processing to each pixel 101.

As illustrated in FIGS. 10 and 11, the first circuit region 22 having a plurality of pixel signal processing units 103 is arranged in a region overlapping the pixel region 12 in the plan view. In the plan view, the vertical scanning circuit 110, the horizontal scanning circuit 111, the reading circuit 112, the output circuit 114, and the control signal generation unit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 having the vertical scanning circuit 110, the horizontal scanning circuit 111, the reading circuit 112, the output circuit 114, and the control signal generation unit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 11. For example, the pixel output signal lines 113 may extend in the row direction, and may be shared by a plurality of pixel signal processing units 103 in corresponding rows. The reading circuit 112 may be provided so as to be connected to the pixel output signal line 113 of each row.

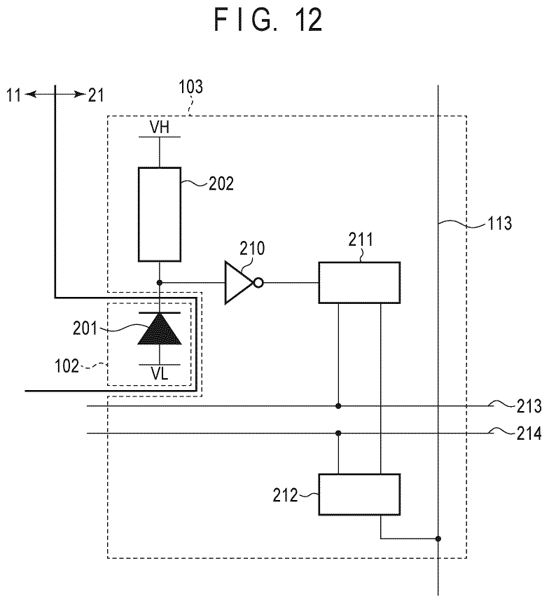

FIG. 12 is a schematic block diagram illustrating a configuration example of one pixel of the photoelectric conversion unit 102 and the pixel signal processing unit 103 according to the present embodiment. FIG. 12 schematically illustrates a more specific configuration example including a connection relationship between the photoelectric conversion unit 102 arranged in the sensor substrate 11 and the pixel signal processing unit 103 arranged in the circuit substrate 21. In FIG. 12, driving lines between the vertical scanning circuit 110 and the pixel signal processing unit 103 in FIG. 11 are illustrated as driving lines 213 and 214.

The photoelectric conversion unit 102 includes an APD 201. The pixel signal processing unit 103 includes a quenching element 202, a waveform shaping unit 210, a counter circuit 211, and a selection circuit 212. The pixel signal processing unit 103 may include at least one of the waveform shaping unit 210, the counter circuit 211, and the selection circuit 212.

The APD 201 generates a charge pair corresponding to incident light by photoelectric conversion. A voltage VL (first voltage) is supplied to the anode of the APD 201. The cathode of the APD 201 is connected to a first terminal of the quenching element 202 and an input terminal of the waveform shaping unit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is-30 V, and the voltage VH (second voltage) is 1 V. The APD 201 may operate in the linear mode or the Geiger mode. In the case of the SPAD, in one embodiment, a potential difference becomes greater than that of the APD of the linear mode, and the effect of avalanche multiplication becomes significant, so that the SPAD is used.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping unit 210 shapes the potential change of the cathode of the APD 201 obtained at the time of photon detection, and outputs a pulse signal. For example, an inverter circuit is used as the waveform shaping unit 210. Although FIG. 12 illustrates an example in which one inverter is used as the waveform shaping unit 210, the waveform shaping unit 210 may be a circuit in which a plurality of inverters is connected in series, or may be another circuit having a waveform shaping effect.

The counter circuit 211 counts the pulse signals output from the waveform shaping unit 210 and holds a digital signal. When a control signal is supplied from the vertical scanning circuit 110 through the driving line 213, the counter circuit 211 resets the held signal.

The selection circuit 212 is supplied with a control signal from the vertical scanning circuit 110 illustrated in FIG. 11 through the driving line 214 illustrated in FIG. 12. In response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 12, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion unit 102 and the pixel signal processing unit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion unit 102 using a switch such as a transistor.

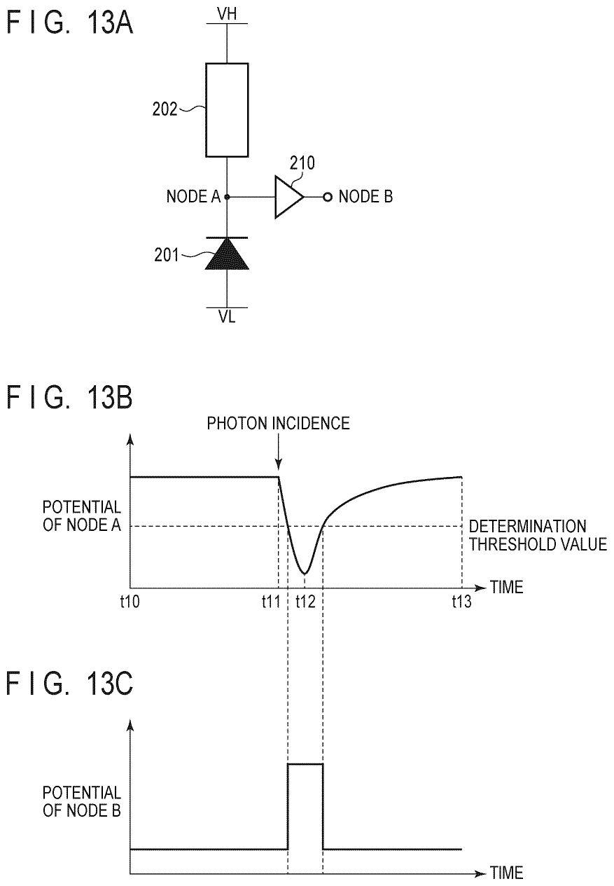

FIGS. 13A, 13B, and 13C are diagrams illustrating an operation of the APD 201 according to the present embodiment. FIG. 13A is a diagram illustrating the APD 201, the quenching element 202, and the waveform shaping unit 210 in FIG. 12. As illustrated in FIG. 13A, the connection node of the APD 201, the quenching element 202, and the input terminal of the waveform shaping unit 210 is referred to as node A. Further, as illustrated in FIG. 13A, an output side of the waveform shaping unit 210 is referred to as node B.

FIG. 13B is a graph illustrating a temporal change in the potential of node A in FIG. 13A. FIG. 13C is a graph illustrating a temporal change in the potential of node B in FIG. 13A. During a period from time t10 to time t11, the voltage VH-VL is applied to the APD 201 in FIG. 13A. When a photon enters the APD 201 at the time t11, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t12, the avalanche multiplication in the APD 201 stops. Thereby, the voltage level of node A does not drop below a certain constant value. Then, during a period from the time t12 to time t13, a current that compensates for the voltage drop flows from the node of the voltage VH to the node A, and the node A is settled to the original potential at the time t13.

In the above-described process, the potential of node B becomes the high level in a period in which the potential of node A is lower than a certain threshold value. In this way, the waveform of the drop of the potential of the node A caused by the incidence of the photon is shaped by the waveform shaping unit 210 and output as a pulse to the node B.

According to the present embodiment, a photoelectric conversion device using an avalanche photodiode which can be applied to the ranging device 1 of the first and second embodiment is provided.

### Fourth Embodiment

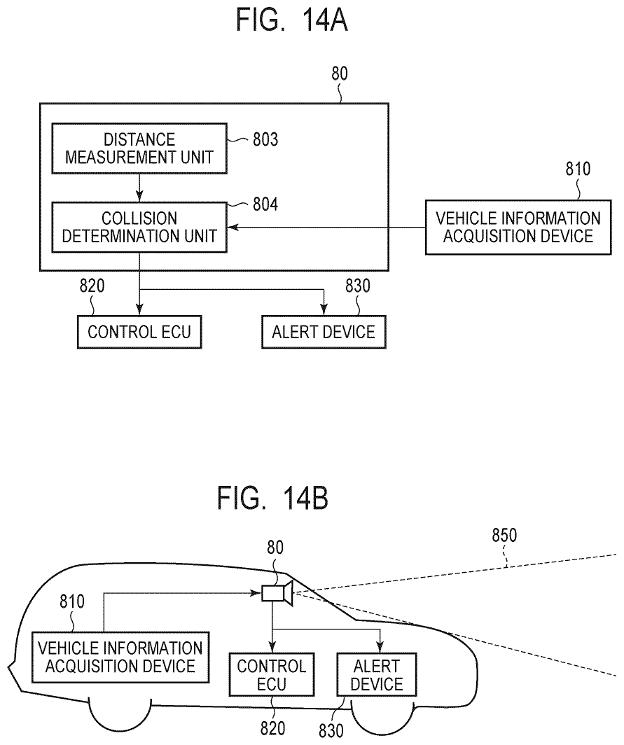

FIGS. 14A and 14B are block diagrams of equipment relating to an in-vehicle ranging device according to the present embodiment. Equipment 80 includes a distance measurement unit 803, which is an example of the ranging device 1 of the above-described embodiments, and a signal processing device (processing device) that processes a signal from the distance measurement unit 803. The equipment 80 includes the distance measurement unit 803 that measures a distance to an object, and a collision determination unit 804 that determines whether or not there is a possibility of collision based on the measured distance. The distance measurement unit 803 is an example of a distance information acquisition unit that obtains distance information to the object. That is, the distance information is information on a distance to the object or the like. The collision determination unit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination unit 804. The equipment 80 is also connected to an alert device 830 that issues an alert to the driver based on the determination result of the collision determination unit 804. For example, when the collision possibility is high as the determination result of the collision determination unit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit that controls the operation of controlling the vehicle as described above.

In the present embodiment, ranging is performed in an area around the vehicle, for example, a front area or a rear area, by the equipment 80. FIG. 14B illustrates equipment when ranging is performed in the front area of the vehicle (ranging area 850). The vehicle information acquisition device 810 as a ranging control unit sends an instruction to the equipment 80 or the distance measurement unit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### MODIFIED EMBODIMENTS

The present disclosure is not limited to the above embodiments, and various modifications are possible. For example, an example in which some of the configurations of any one of the embodiments are added to other embodiments and an example in which some of the configurations of any one of the embodiments are replaced with some of the configurations of other embodiments are also embodiments of the present disclosure.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A≠B) is omitted. This is because it is assumed that “A is not B” is considered when “A is B” is described.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

It should be noted that any of the embodiments described above is merely an example of an embodiment for carrying out the present disclosure, and the technical scope of the present disclosure should not be construed as being limited by the embodiments. That is, the present disclosure can be implemented in various forms without departing from the technical idea or the main features thereof.

According to the present disclosure, a ranging device capable of improving a frame rate is provided.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-088771, filed May 30, 2023, which is hereby incorporated by reference herein in its entirety.

What is claimed is:

1. A ranging device comprising:
a counting unit configured to output a time count value indicating an elapsed time from a start of time counting;
a control unit configured to control a light emission timing in a light emitting device divided into a plurality of emitting regions and a start timing of the time counting in the counting unit;
a receiving unit including a plurality of pixels divided into a plurality of receiving regions so as to correspond one-to-one to the plurality of emitting regions, each of the plurality of pixels generating a light reception signal based on incident light in a measurement period from a light emission timing until a measurement ends in a corresponding emitting region and receiving region;
a latch unit configured to generate a light reception time value indicating an elapsed time from the start of the time counting until the incident light is incident on any one of the plurality of receiving regions based on the time count value and a plurality of light reception signals respectively output from pixels in the plurality of receiving regions; and
a calculation unit configured to calculate a flight time of light emitted from the light emitting device based on the light reception time value,
wherein light emission timings of the plurality of emitting regions are different from each other, and a time difference between any two light emission timings of the plurality of emitting regions is shorter than a length of a measurement period in each of the plurality of receiving regions, and
wherein the calculation unit calculates the flight time corresponding to each of the plurality of receiving regions based on the light reception time value and the time difference.

2. The ranging device according to claim 1,
wherein the control unit performs control so that a light emission timing of a reference emitting region that is a emitting region emitting light at the earliest time among the plurality of emitting regions and a start timing of the time counting are synchronized with each other, and
wherein the time difference is based on the light emission timing of the reference emitting region and a light emission timing of another emitting region.

3. The ranging device according to claim 2, wherein after all of the plurality of receiving regions end measurement in a first measurement period, light emission of the reference emitting region in a second measurement period subsequent to the first measurement period is performed.

4. The ranging device according to claim 3, wherein the calculation unit calculates the flight time corresponding to a receiving region for other than the reference emitting region by subtracting the time difference from the light reception time value.

5. The ranging device according to claim 2, wherein before all of the plurality of receiving regions end measurement in a first measurement period, light emission of the reference emitting region in a second measurement period subsequent to the first measurement period is performed.

6. The ranging device according to claim 5, wherein when the light reception time value is equal to or greater than the time difference, the calculation unit calculates the flight time corresponding to a receiving region for other than the reference emitting region by subtracting the time difference from the light reception time value.

7. The ranging device according to claim 5, wherein when the light reception time value is less than the time difference, the calculation unit calculates the flight time corresponding to a receiving region for other than the reference emitting region by subtracting the time difference from the light reception time value and adding an upper limit value of the time count value to the light reception time value.

8. The ranging device according to claim 3, wherein the calculation unit outputs the light reception time value as the flight time corresponding to the reference emitting region.

9. The ranging device according to claim 2 further comprising a time difference generation unit configured to generate the time difference based on a light emission time signal indicating the light emission timing and the time count value.

10. The ranging device according to claim 9, wherein the time difference generation unit generates the time difference by holding the time count value at a time when the light emission time signal is input.

11. The ranging device according to claim 1, wherein the plurality of emitting regions are arranged such that two emitting regions in which light emission timings are continuous are not adjacent to each other.

12. The ranging device according to claim 1, wherein a sequence of light emission timings in the plurality of emitting regions is random.

13. The ranging device according to claim 1, wherein at least two measurement periods in the plurality of receiving regions partially overlap each other.

14. The ranging device according to claim 1 further comprising a logic circuit configured to output, to the latch unit, a logical sum of the plurality of light reception signals respectively output from pixels of the plurality of receiving regions.

15. The ranging device according to claim 1 further comprising a selection circuit configured to distribute output signals of the calculation unit as a plurality of output signals respectively corresponding to the plurality of receiving regions based on the plurality of light reception signals respectively output from pixels of the plurality of receiving regions.

16. The ranging device according to claim 1,
wherein the plurality of pixels is arranged to form a plurality of rows and a plurality of columns, and
wherein one of the plurality of receiving regions includes a plurality of pixels arranged in one row.

17. The ranging device according to claim 1,
wherein the plurality of pixels is arranged to form a plurality of rows and a plurality of columns, and
wherein the latch unit and the calculation unit process, in common, light reception signals from pixels of the plurality of receiving regions arranged in one column.

18. The ranging device according to claim 17,
wherein a plurality of the latch units are arranged respectively corresponding to the plurality of columns, and
wherein the common time count value is input to a plurality of the latch units.

19. Equipment comprising:
the ranging device according to claim 1; and
a processing device configured to process distance information acquired by the ranging device.

20. A moveable body comprising:
the ranging device according to claim 1; and
a movable body control unit configured to control the movable body based on distance information acquired by the ranging device.
